(19) United States
(12) Patent Application Publication
(10) Pub. No.: US 2012/0111687 A1
(43) Pub. Date: May 10, 2012

(54) ROLLER PAWL FOR USE IN RATCHET AND PAWL STYLE CLUTCHES

(76) Inventor: Jody A. Peterson, Rockford, IL (US)

(21) Appl. No.: 12/940,102

(22) Filed: Nov. 5, 2010

(51) Int. Cl. F16D 41/12; B23P 6/00; B23P 11/00

(52) U.S. Cl. 192/46; 29/428; 29/402.08

(57) ABSTRACT

A pawl and ratchet clutch assembly for use in transmitting rotational drive torque has a rotatable pawl; a spring for urging the pawl towards the ratchet; and, a member rotatably mounted between the pawl and the spring for rotating along the spring as the pawl moves relative to the spring.

### BACKGROUND OF THE INVENTION

The present invention relates generally to pawl and ratchet clutches for use on unidirectional drive systems, and more specifically to a pawl roller for minimizing wear of the pawl. The pawl and ratchet is particularly suitable for use in starters for starting engines, such as aircraft turbine engines.

Pawl and ratchet clutches are often utilized in unidirectional drive systems for transmitting drive torque from a drive shaft to a driven shaft. For example, starters of the type commonly used to start engines, in particular the turbine engines of modern gas turbine powered aircraft often employ a pawl and ratchet type clutch which functions to transmit rotational drive torque from a drive shaft of the starter to drive the engine being started to starting speed. One of type of starter often employing a pawl and ratchet clutch is the pneumatic starter, also known as an air turbine starter, such as disclosed, for example, in U.S. Pat. Nos. 3,727,733; 4,899,534; 4,914,906; and 4,926,631.

A pawl and ratchet clutch of a type commonly used in such pneumatic starters includes a toothed ratchet member mounted on a central drive shaft and a plurality of pivotal pawls supported from and rotating with a driven output shaft disposed coaxially about the drive shaft. The pawls are operatively disposed at circumferentially spaced intervals about the ratchet member in cooperative relationship therewith. Each pawl is biased to pivot radially inwardly by a leaf spring operatively associated therewith to engage a tooth of the ratchet member thereby coupling the drive shaft in driving relationship to the driven output shaft so long as the pawls remain engaged with the teeth of the ratchet member. The drive shaft is connected, either directly or through suitable reduction gearing as desired, to the shaft of the pneumatic starter turbine that is powered by extracting energy from a flow of pressurized fluid passed through a starter turbine.

To start the turbine engine, the output end of the driven output shaft of the starter is connected, for example by mating splines, to an engine shaft operatively connected to the main engine shaft through a gear box, and pressurized fluid, typically compressed air, is passed through the turbine of the pneumatic starter. As the starter turbine extracts energy from the compressed air passing therethrough, the drive shaft of the starter turbine is rotated to rotatably drive the output shaft of the starter, and consequently the turbine engine shaft connected thereto, through the engagement of the pawls pivotally mounted to the output shaft with the ratchet member mounted to the drive shaft. Typically, the starter is designed to accelerate the engine shaft from zero to a predetermined cut-off speed, typically of about 5000 revolutions per minute, in about one minute or less.

Once engine light-off has occurred and the engine shaft is rotating at the desired cut-off speed, the flow of pressurized air to the starter turbine is terminated. With the flow of pressurized air to the starter turbine shut-off, the drive shaft of the starter rapidly slows down. Consequently, the ratchet member mounted to the starter drive shaft also rapidly slows down, while the pawls supported from the starter output shaft continue to rotate with the engine of the operating turbine engine at the relatively high cut-off speed. The pawls become disengaged from the ratchet member if the rotational speed of the output shaft exceeds a threshold speed whereat the pawls lift-off of the ratchet member, that is pivot radially outwardly out of contact with the teeth of the ratchet member, under the influence of the centrifugal forces acting thereon due to the continued rotation of the pawls at the relatively high speed of the engine shaft and remain disengaged from the ratchet member so long as the rotational speed of the engine shaft remains high enough that the centrifugal forces acting on the pawls exceed the opposing moment imposed on the pawls by the force of their associated bias springs.

When the turbine engine is later shut-down, the operating speed of the engine shaft of the turbine engine to which the output shaft of the starter is connected rapidly decreases as the turbine engine spools down. As the starter shaft slows down, the centrifugal force on the pawls consequently decreases and the force of each bias spring progressively pivots its associated pawl radially inwardly again toward the ratchet member until each pawl reengages a ratchet tooth on the non-rotating ratchet member so as to reengage the clutch. The speed at which the reengagement of the pawls with the ratchet member occurs, commonly referred to as the reengagement speed, is less than the pawl lift-off speed by an amount commonly referred to as the clutch hysteresis.

### SUMMARY OF THE INVENTION

According to an embodiment shown herein a pawl and ratchet clutch assembly for use in transmitting rotational drive torque has a rotatable pawl; a spring for urging the pawl towards the ratchet; and, a member rotatably mounted between the pawl and the spring for rotating along the spring as the pawl moves relative to the spring.

According to a further embodiment shown herein, a pawl for engaging a ratchet has a body having an axis for rotation thereabout, a spring for urging the body about the axis towards the ratchet; and, a member rotatably mounted upon the body for rotating along the spring as the pawl moves relative to the spring.

According to a still further embodiment shown herein, a pawl and ratchet clutch assembly for use in transmitting rotational drive torque to start a jet engine has a rotatable pawl; a spring for urging the pawl towards the ratchet; and, a member rotatably mounted between the pawl and the spring for rotating along the spring as the pawl moves relative to the spring.

According to a still further embodiment shown herein, a method for inserting a roller pawl in a clutch of an air turbine starter includes the steps of creating an opening in a heel portion of a pawl, placing a rotating member in the opening in the heel portion for rotating therein, and attaching the pawl to a clutch carrier.

These and other features of the present invention can be best understood from the following specification and drawings, the following of which is a brief description.

### BRIEF DESCRIPTION OF THE DRAWINGS

FIG. 1 is a partially-sectioned side view of a prior art starter having a pawl and ratchet assembly.

FIG. 2 is a sectional side view of the pawl and ratchet assembly incorporating a rolling member.

### DETAILED DESCRIPTION OF THE PREFERRED EMBODIMENT

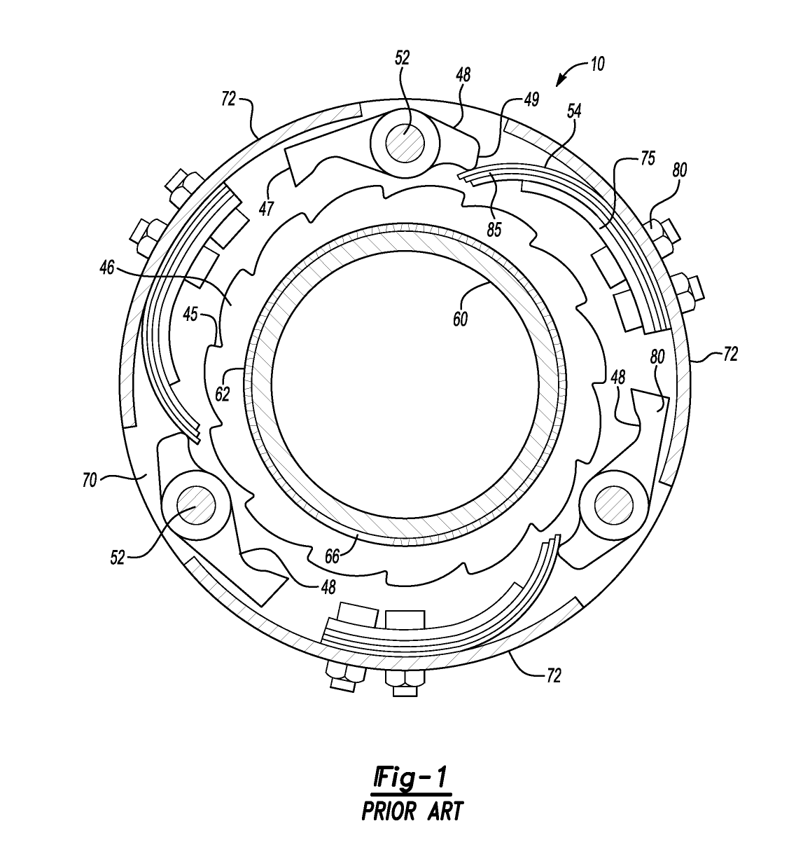

Referring now to the prior art shown in FIG. 1, there is depicted therein a pneumatic starter 10 of the general type often utilized to start gas turbine engines, such as for example aircraft turbine engines (not shown). The pneumatic starter 10, also known as an air turbine starter, includes a turbine wheel (not shown) which is driven by a compressed gas, most commonly compressed air from an external supply, passing therethrough so as to extract energy from the gas and convert the extracted energy to mechanical energy through a gear train (not shown) in a manner well known in the art. Although the present invention is described herein with reference to an air turbine starter, it is to be understood that the pawl and ratchet assembly of the present invention has application on any unidirectional drive system wherein a pawl and ratchet clutch is utilized to transmit rotation from a driving shaft to a driven shaft.

Extending axially outwardly from the transmission (not shown) is an output shaft 60 which has means, such as for example splines 62, for engaging an engine shaft (not shown) in the gear box of the turbine engine (not shown) on which the starter 10 is utilized to start the turbine engine. The output shaft 60 is rotatably supported on bearing means 66. The aforementioned pawls 48 (or “body”), of which there are typically three, are supported on a clutch carrier 70 of the pneumatic starter 10 that extends radially outward from the output shaft 60. Each of the pawls 48 is pivotally supported on a shaft 52 mounted to and extending axially from the clutch carrier 70 of the pneumatic starter 10 such that the pawls 48 are disposed in cooperation with the ratchet member 46 at equally spaced intervals about the circumference of and in radially spaced relationship from the ratchet member 46.

Additionally, each of the pawls 48 is biased to pivot about its support shaft 52 to rotate the toe end 47 thereof radially inwardly towards the ratchet member 46 under the force of a bias spring 54 mounted to an axial flange portion 72 of the clutch carrier 70. Each bias spring 54 may comprise a leaf spring operatively bearing against the heel 49 of its associated pawl 48 so as to function during operation of the starter 10 to load the toe end 47 of its associated pawl 48 into engagement with the teeth of the ratchet member 46 of the pawl and ratchet clutch to ensure transmission of torque from a ring gear (not shown) in the pneumatic starter 10 to the output shaft 60 until the output shaft 60 has reached a relatively high desired cut-off speed, for example about 5000 rpm, at which the pawls 48 pivot away from the ratchet member 46 under the influence of centrifugal force after disengagement from the teeth 45 of the ratchet member 46 upon slowing down of the ratchet member 46 after termination of the flow of compressed air through the starter turbine (not shown).

When the pawls 48 are engaged with the teeth of the ratchet 46 during operation of the starter 10, the output shaft 60, and the engine shaft of the turbine engine (not shown) connected therewith, are driven in rotation through the engaged pawl 48 and ratchet member 46.

After the shaft of the turbine engine engaged with the output shaft 60 of the starter 10 has reached the preselected desired engine speed, the flow of compressed air to and through the turbine wheel (not shown) is shut off. As a result, drive power is no longer being delivered to the ratchet member 46. Consequently, the ratchet member 46 slows down and its rotational speed rapidly decreases, while the output shaft 60 of the starter 10 and the pawls 48 mounted thereto continue to rotate at the higher engine speed, thereby causing the pawls 48 to become disengaged from the ratchet member 46 and pivot away from the ratchet member 46. Centrifugal force acting on the pawls 48 overcomes the force provided by spring 54 to cause the pawls 48 to rotate away from and disengage the ratchet member 46.

If the turbine engine is later shut down, the starter output shaft 60 begins to slow down and its rotational speed steadily decreases as the turbine engine spools down. As the output shaft 60 coasts down, the centrifugal force acting on the pawls 48 so as to urge the toe ends 47 of the pawls 48 radially outwardly, steadily decreases and the toe end 47 of each pawl 48 begins to pivot radially inwardly toward the ratchet member 46 under the bias force applied by the springs 54 on the heel 49 of the pawls 48 until the toe ends 47 of the pawls 48 re-engage with the teeth of the ratchet member 46.

A spring clamp 75 is attached by bolts 80 to the axial flange portion 72 of the clutch carrier 70 to hold the spring 54.

Existing ratchet and pawl clutch designs experience spring failures and pawl heel wear. A spring fracture and pawl heel wear may alter the performance of the unit in a negative manner. The source of spring fractures and pawl heel wear is the contact forces experienced between the spring end 90 and pawl heel 49 during rotation of the pawl 48. During faster rotation, centrifugal force may rotate the pawl 48 radially outward, here in a counter-clockwise direction against the force and sliding/rubbing of the spring 54 against the pawl heel 49. As rotation slows, the spring forces the pawl to rotate in a clockwise direction causing the spring to slide/rub against the heel 49. Further, as rotational speed fluctuates during operation, centrifugal force changes, as does the deflection of the spring, and subsequent contact and/or sliding forces wear the parts.

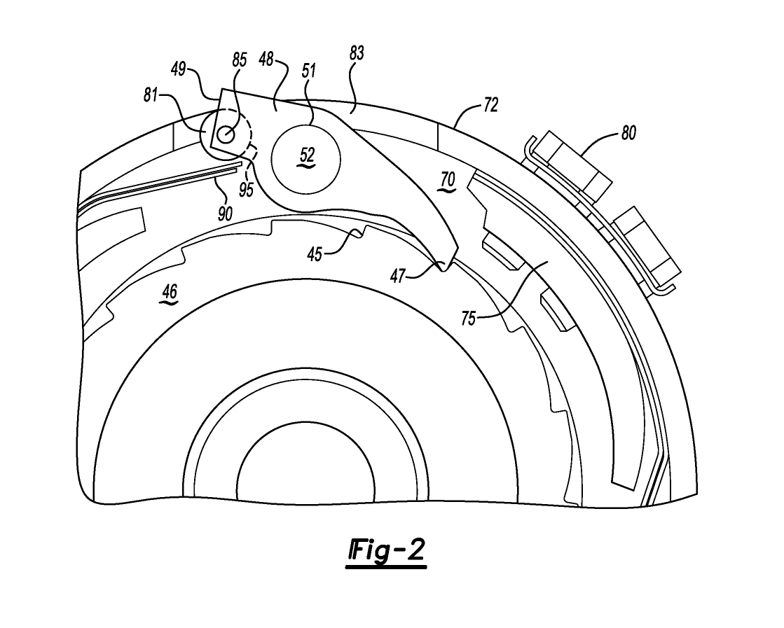

Referring now to FIG. 2, a rotating member 81, such as a wheel, pin or ball or the like, may be attached by a pin 85 to the heel 49 of the pawl 48. The rotating member 81 rides on an unsupported spring end 90 of the spring 54. As the pawl 48 is influenced by centrifugal force as the assembly 10 rotates, the rotating member 81 engages and rolls along the spring end 90 as the pawl 48 rotates clockwise and counter-clockwise. The rotating member 81 rotating along the spring end 90 minimizes any friction and/or sliding forces that was caused by the relative movement on the heel of the spring end 90 and the heel 49 as the pawl 48 rotate in a clockwise and counterclockwise direction. The wheel 81 extends beyond dimensions of the heel 49 and into a discontinuity 83 along the axial flange portion 72 that also receives the pawl 48.

The rotating member 81 reduces sliding/rubbing between the spring end 90 and the heel 49 thereby minimizing wear caused by such sliding/rubbing.

To assemble a pawl for use herein, a user evacuates enough material in the heel 49 of the pawl 48 and creates a hole 51 in which the shaft 52 is fitted for rotation thereabout. Similarly, a hole 87 is drilled in the heel 49 to insert the pin 85 therein about which the rotating member 81 rotates. Alternatively, the heel 49 is cast, or the like, with an opening 95 for receiving the rotating member 81. A pawl 48 without a rotating member (see FIG. 1) may be replaced with a pawl 48 with a rotating member 81 by separating the pawl without a rotating member from the shaft on inserting the pawl 81 with a rotating member therein while deflecting the spring end 90.

Although the invention has been shown and described with respect to a best mode embodiment exemplary thereof, it should be understood by those skilled in the art that various modifications, changes, omissions and additions in the form and detail thereof may be made without departing from the spirit and scope of the invention. For example, although spring end 90 of FIG. 2 is depicted as a leaf spring, the pawl 48 with rotating member 81 can be used in conjunction with any spring means suitably configured and disposed for biasing the toe portion 47 of the pawl 48 radially inwardly toward the ratchet member 46.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A pawl and ratchet clutch assembly for use in transmitting rotational drive torque said assembly comprising:
a rotatable pawl;
a spring for urging said pawl towards a ratchet; and,
a member rotatably mounted between said pawl and said spring, said member rotating along said spring as said pawl moves relative to said spring.

2. The assembly of claim 1 wherein said member comprises a wheel.

3. The assembly of claim 1 wherein said pawl has a toe for engaging said ratchet and a heel upon which said member is mounted.

4. The assembly of claim 3 wherein said pawl further comprises an axis about which said pawl rotates said axis disposed between said toe and said heel.

5. The assembly of claim 3 wherein said member extends beyond an outer edge of said heel.

6. The assembly of claim 1 wherein said member is a pin.

7. The assembly of claim 1 further comprising an axial flange disposed about said rotatable pawl, said flange having an opening for receiving said wheel.

8. The assembly of claim 7 further comprising an axial flange disposed about said rotatable pawl, said flange having an opening for receiving said pawl as said pawl rotates.

9. A pawl for engaging a ratchet, said pawl comprising:
a body having an axis for rotation thereabout as urged by a spring towards said ratchet; and,
a member rotatably mounted upon said body for rotating along said spring as said pawl moves relative to said spring.

10. The pawl of claim 9 wherein said member comprises a wheel.

11. The pawl of claim 9 wherein said body has a toe for engaging said ratchet and a heel upon which said member is mounted.

12. The pawl of claim 11 wherein said axis about which said body rotates is disposed between said toe and said heel.

13. The pawl of claim 11 wherein said member extends beyond an outer edge of said heel.

14. The pawl of claim 9 wherein said member is a pin.

15. A pawl and ratchet clutch assembly for use in transmitting rotational drive torque to start a jet engine said assembly comprising:
a clutch carrier;
a rotatable pawl attached to said clutch carrier;
a spring for urging said pawl towards a ratchet; and,
a member rotatable mounted between said pawl and said spring for rotating along said spring as said pawl moves relative to said spring.

16. The assembly of claim 13 wherein said member comprises a wheel.

17. The assembly of claim 13 wherein said pawl has a toe for engaging said ratchet and a heel upon which said member is mounted.

18. The assembly of claim 15 wherein said pawl further comprises an axis about which said pawl rotates said axis disposed between said toe and said heel.

19. The assembly of claim 15 wherein said member extends beyond an outer edge of said heel.

20. The assembly of claim 13 wherein said member is a pin.

21. The assembly of claim 15 further comprising an axial flange disposed about said rotatable pawl and mounted on said clutch carrier, said flange having an opening for receiving said member as said pawl rotates.

22. The assembly of claim 21 wherein said flange opening receiving said pawl as said pawl rotates.

23. A method for inserting a roller pawl in a clutch of an air turbine starter, said method comprising:
creating an opening in a heel portion of a pawl,
placing a rotating member in said opening in said heel portion for rotating therein, and
attaching said pawl to a clutch carrier.

24. The method of claim 23 further comprising:
removing a pawl not having a rotatable member before installing a pawl having a rotatable member.
